(19) United States
(12) Patent Application Publication
(10) Pub. No.: US 2025/0037069 A1
(43) Pub. Date: Jan. 30, 2025

(54) DELIVERY SUPPORT APPARATUS, DELIVERY SUPPORT METHOD, AND DELIVERY SUPPORT PROGRAM

(71) Applicant: Nippon Telegraph and Telephone Corporation, Tokyo (JP)

(72) Inventors: Manami OGAWA, Musashino-shi, Tokyo (JP); Shunsuke KANAI, Musashino-shi, Tokyo (JP); Kenji Murase, Musashino-shi, Tokyo (JP); Masataka Sato, Musashino-shi, Tokyo (JP); Kazuaki AKASHI, Musashino-shi, Tokyo (JP); Hiroaki MATSUBAYASHI, Musashino-shi, Tokyo (JP); Shohei Nishikawa, Musashino-shi, Tokyo (JP)

(21) Appl. No.: 18/716,061

(22) PCT Filed: Dec. 8, 2021
(86) PCT No.: PCT/JP2021/045183

§ 371 Date: Jun. 3, 2024

(51) Int. Cl. G06Q 10/0835

(52) U.S. Cl. CPC G06Q 10/08355

(57) ABSTRACT

A delivery support device includes a derivation unit that derives a route of a resource in a delivery apparatus, for minimizing a maximum value of a time during which the resource is exhausted at a plurality of first locations. The derivation unit derives the route on the basis of a branch-and-bound method using a relaxation problem of aggregating a plurality of second locations of which a delivery order is not determined among the plurality of first locations into one point.

### TECHNICAL FIELD

An embodiment described herein relates to a delivery support device, a delivery support method, and a delivery support program.

### BACKGROUND ART

A delivery vehicle is one of main means for supplying resources to a delivery destination.

A problem of appropriately determining a route of a delivery vehicle in order to efficiently deliver resources to a plurality of delivery destinations is a problem of high interest. For example, at the time of a large-scale disaster, it is required to select a route that minimizes the time for exhaustion of resources such as power and water at a delivery destination.

As a method for selecting a route as described above, there is a method by using a branch-and-bound method. The branch-and-bound method is a technique often used to obtain an exact solution in a vehicle routing problem (VRP).

For example, in Non Patent Literature 1, a maximum value (maximum exhaustion time) of a time during which resources at a plurality of delivery destinations are exhausted is set as an objective function. An optimization problem that minimizes the objective function is solved according to the branch-and-bound method.

### CITATION LIST

### Non Patent Literature

Non Patent Literature 1: M. Ogawa et al. “A route searching method using two-dimension coordinates”, IEICE, DOI:10.34385/proc.63.E4-3, 2020.

### SUMMARY OF INVENTION

### Technical Problem

However, in Non Patent Literature 1, there are concerns about the following points regarding the relaxation problem used in a bound operation in the branch-and-bound method.

First, since a movement time between locations is proportional to a Euclidean distance, the movement time on a map cannot be used. Thus, a resource exhaustion time may deviate from the actual time.

Since it is not possible to determine whether or not the relaxation problem is NP-difficult, there is no guarantee that an optimal solution can be obtained. Thus, there is a possibility that a solution finally obtained according to the branch-and-bound method is not an exact solution.

The time for which a delivery vehicle stays at a delivery destination is not considered. Thus, it is difficult to cope with a case where the time for which the delivery vehicle stays is different for each delivery destination.

The present invention has been made in view of the above circumstances, and an object of the present invention is to provide means for efficiently obtaining an optimal resource delivery route.

### Solution to Problem

A delivery support device according to one aspect includes a derivation unit that derives a route of a resource in a delivery apparatus, for minimizing a maximum value of a time during which the resource is exhausted at a plurality of first locations. The derivation unit derives the route based on a branch-and-bound method using a relaxation problem of aggregating a plurality of second locations of which a delivery order is not determined among the plurality of first locations into one point.

### Advantageous Effects of Invention

According to the embodiment, it is possible to provide means for efficiently obtaining an optimal resource delivery route.

### BRIEF DESCRIPTION OF DRAWINGS

FIG. 1 is a schematic diagram illustrating an example of a configuration of a delivery system according to an embodiment.

FIG. 2 is a block diagram illustrating an example of a hardware configuration of a delivery support device according to the embodiment.

FIG. 3 is a block diagram illustrating an example of a functional configuration of the delivery support device according to the embodiment.

FIG. 4 is a diagram illustrating an example of a configuration of delivery vehicle information according to the embodiment.

FIG. 5 is a diagram illustrating an example of a configuration of the delivery destination information according to the embodiment.

FIG. 6 is a diagram illustrating an example of a configuration of movement time information according to the embodiment.

FIG. 7 is a flowchart illustrating an example of a delivery support operation in the delivery support device according to the embodiment.

FIG. 8 is a diagram illustrating a grace time and a stay time in a specific example.

FIG. 9 is a diagram illustrating a movement time in a specific example.

FIG. 10 is a diagram illustrating an idle time in a specific example.

### DESCRIPTION OF EMBODIMENTS

Hereinafter, an embodiment will be described with reference to the drawings. Note that in the following description, constituents having the same function and configuration are denoted by the same reference signs. In a case where a plurality of constituents having a common reference sign are distinguished from each other, the constituents are distinguished by an additional reference sign (for example, a hyphen and a number such as “−1”) attached after the common reference sign.

### 1. CONFIGURATION

A configuration of a delivery system according to an embodiment will be described.

### 1.1 Overall Configuration

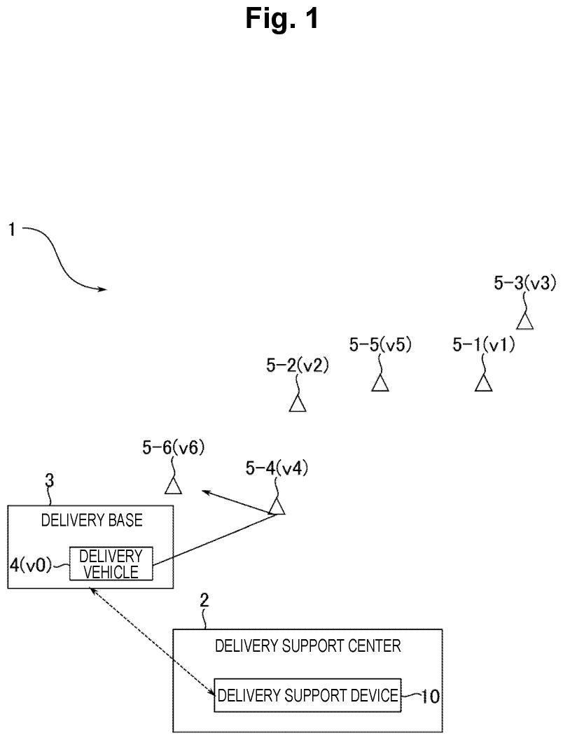

First, a configuration of the delivery system according to the embodiment will be described. FIG. 1 is a block diagram illustrating an example of the configuration of the delivery system according to the embodiment.

As illustrated in FIG. 1, a delivery system 1 is a system for supplying a resource to a certain region by using a delivery vehicle 4. The delivery system 1 includes a delivery support center 2, a delivery base 3, and a plurality of delivery destinations 5-1, 5-2, 5-3, 5-4, 5-5, and 5-6. Hereinafter, each of the plurality of delivery destinations 5-1 to 5-6 may be referred to as a “delivery destination 5” when not particularly distinguished.

The delivery support center 2 generates a delivery plan for comprehensively controlling delivery of resources in the delivery system 1. The delivery support center 2 is configured to perform wireless connection with the delivery base 3. As a result, the delivery support center 2 wirelessly transmits a generated optimal route for delivery to the delivery base 3.

The delivery support center 2 also includes a delivery support device 10. The delivery support device 10 is a computer that supports generation of an optimal route for delivery in the delivery support center 2. Details of the delivery support device 10 will be described below.

The delivery base 3 is, for example, a place where resources are stored. At least one delivery vehicle 4 is disposed in the delivery base 3. The delivery base 3 instructs the delivery vehicle 4 to deliver a resource on the basis of the optimal route received from the delivery support center 2.

The delivery vehicle 4 is an apparatus such as a vehicle capable of delivering a resource. The delivery vehicle 4 delivers a resource to the delivery destination 5 along the optimal route received from the delivery support center 2. The action purpose of the delivery vehicle 4 is, for example, to minimize a maximum value (maximum exhaustion time Tₘₐₓ) of a time (exhaustion time T) during which resources are exhausted in the plurality of delivery destinations 5-1 to 5-6. The action purpose of the delivery vehicle 4 is realized by the optimal route transmitted from the delivery support center 2.

The delivery destination 5 is a location to which a resource is delivered by the delivery vehicle 4. The delivery destination 5 is, for example, an evacuation spot at the time of disaster occurrence. The resource is, for example, an infrastructure resource such as water or electric power. Resources are stored in advance at the delivery destination 5. At the time of a disaster, the resources stored at the delivery destination 5 are gradually consumed by evacuees.

Hereinafter, locations of the delivery vehicle 4 and the delivery destination 5 on the map (that is, on a two-dimensional plane) are associated vertices v. In the example in FIG. 1, the delivery vehicle 4 is associated with the vertex v₀. The plurality of delivery destinations 5-1 to 5-6 are respectively associated with vertices v₁ to v₆.

### 1.2 Delivery Support Device

Next, a configuration of the delivery support device according to the embodiment will be described.

### 1.2.1 Hardware Configuration

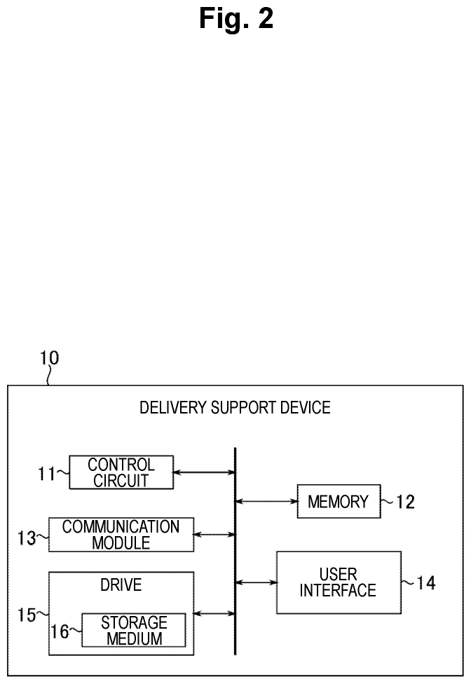

FIG. 2 is a block diagram illustrating an example of a hardware configuration of the delivery support device according to the embodiment. As illustrated in FIG. 2, the delivery support device 10 includes a control circuit 11, a memory 12, a communication module 13, a user interface 14, and a drive 15.

The control circuit 11 is a circuit that entirely controls each constituent of the delivery support device 10. The control circuit 11 includes a central processing unit (CPU), a random access memory (RAM), a read only memory (ROM), and the like.

The memory 12 is an auxiliary storage device of the delivery support device 10. The memory 12 includes, for example, a hard disk drive (HDD), a solid state drive (SSD), and a memory card. The memory 12 stores various types of information used for a delivery support operation and a delivery support program. The delivery support program may be stored in the memory 12 by being transmitted from the outside of the delivery support device 10 via a network (not illustrated).

The delivery support operation is a series of operations executed to support generation of a resource delivery plan in the delivery system 1. The delivery support operation includes, for example, an operation for examining in what order a resource is delivered to the delivery destination 5 such that the maximum exhaustion time Tₘₐₓ can be minimized. The delivery support program is a program for causing the delivery support device 10 to execute the delivery support operation. Details of the delivery support operation will be described later.

The communication module 13 is a circuit used for transmission and reception of data via a network.

The user interface 14 is a circuit for performing information communication between a user and the control circuit 11. The user interface 14 includes an input device and an output device. The input device includes, for example, a touch panel and an operation button. The output device includes, for example, a liquid crystal display (LCD), an electroluminescence (EL) display, and a printer. The user interface 14 converts an input from a user (user input) into an electrical signal, and then transmits the electrical signal to the control circuit 11. The user interface 14 outputs an execution result of the delivery support program received from the control circuit 11 to the user.

The drive 15 is a device for reading a program stored in a storage medium 16. The drive 15 includes, for example, a compact disk (CD) drive and a digital versatile disk (DVD) drive.

The storage medium 16 is a medium that accumulates information such as programs through electrical, magnetic, optical, mechanical, or chemical action. The storage medium 16 may store the delivery support program.

### 1.2.2 Functional Configuration

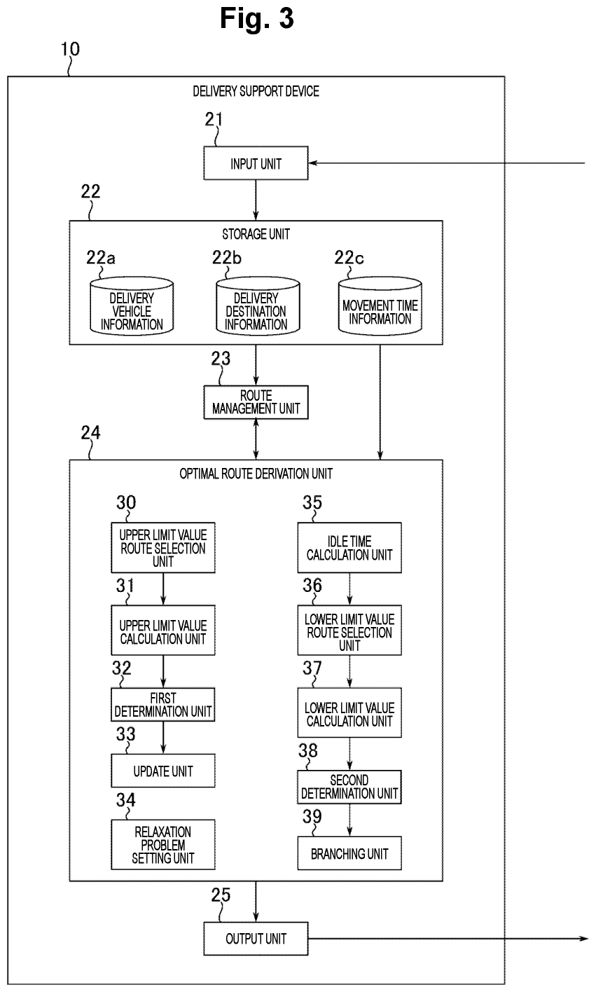

FIG. 3 is a block diagram illustrating an example of a functional configuration of the delivery support device according to the embodiment.

The CPU of the control circuit 11 loads the delivery support program stored in the memory 12 or the storage medium 16 onto the RAM. The CPU of the control circuit 11 interprets and executes the delivery support program loaded onto the RAM to control the memory 12, the communication module 13, the user interface 14, the drive 15, and the storage medium 16. As a result, as illustrated in FIG. 3, the delivery support device 10 functions as a computer including an input unit 21, a storage unit 22, a route management unit 23, an optimal route derivation unit 24, and an output unit 25.

The input unit 21 stores various types of information in the storage unit 22 on the basis of an input from a user. The various types of information stored in the storage unit 22 include, for example, delivery vehicle information 22a, delivery destination information 22b, and movement time information 22c.

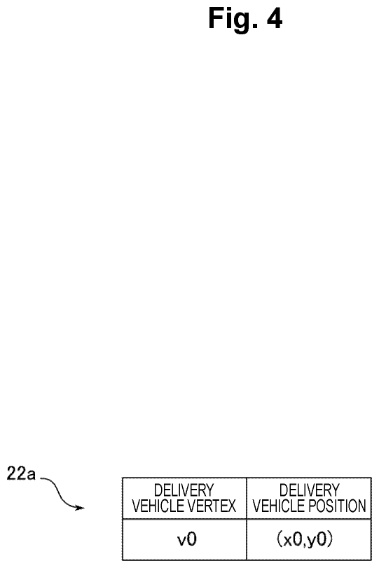

FIGS. 4 to 6 are conceptual diagrams respectively illustrating examples of configurations of delivery vehicle information, delivery destination information, and movement time information according to the embodiment.

As illustrated in FIG. 4, the delivery vehicle information 22a is information regarding the delivery vehicle 4. Specifically, the delivery vehicle information 22a includes information such as a delivery vehicle vertex and a position.

The delivery vehicle vertex uniquely identifies a vertex name associated with the delivery vehicle 4.

The delivery vehicle position is current position information of the delivery vehicle 4. The delivery vehicle position is represented by, for example, two-dimensional coordinates (X, Y). The delivery vehicle position may be represented by latitude and longitude.

In the example in FIG. 4, the delivery support device 10 can ascertain that the delivery vehicle 4 associated with the vertex v₀ is at the delivery vehicle position (x₀, y₀) from the delivery vehicle information 22a.

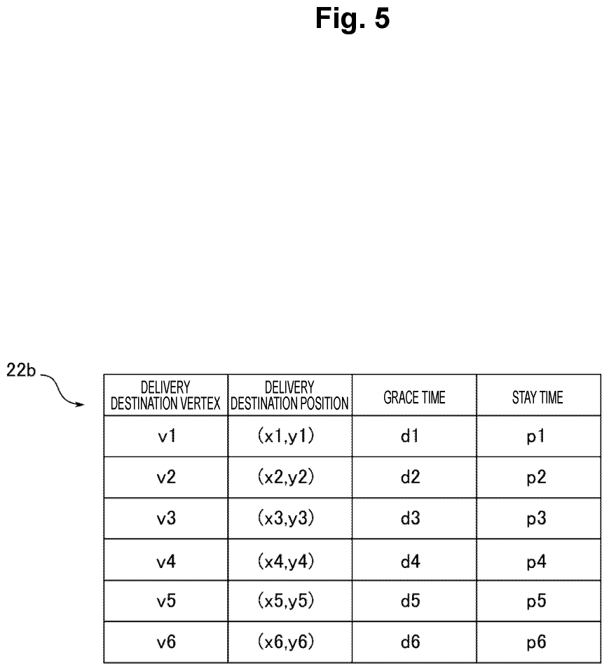

As illustrated in FIG. 5, the delivery destination information 22b is information of the delivery destination 5 where resource delivery is awaited. Specifically, the delivery destination information 22b includes information such as a delivery destination vertex, a delivery destination position, a grace time, and a stay time.

The delivery destination vertex uniquely identifies a vertex name associated with the delivery destination 5.

The delivery destination position is position information of the delivery destination 5. The delivery destination position is represented by, for example, two-dimensional coordinates (x, y). The delivery destination position may be represented by latitude and longitude similarly to the delivery vehicle position.

The grace time d is information indicating a time from the reference time until resources stored at the delivery destination 5 are exhausted. The reference time is fixed to, for example, the start time of the delivery support operation. Accordingly, the grace time d is fixed while the delivery support operation is being executed. The grace time d may be replaced with a resource exhaustion time.

The stay time p is information indicating a time from the start to the end of resource supply after the delivery vehicle 4 arrives at the delivery destination 5. During the stay time p, the delivery vehicle 4 does not move from the delivery destination 5. After the stay time p elapses from the arrival of the delivery vehicle 4 at the delivery destination 5, the delivery vehicle 4 departs for the next delivery destination 5.

In the example of FIG. 5, the delivery support device 10 can ascertain that the delivery destination 5-i associated with the vertex vᵢ is at the delivery destination position (xᵢ, yᵢ) from the delivery destination information 22b. The delivery support device 10 can ascertain that the delivery destination 5-i has the grace time dᵢ until the resource is exhausted, and the stay time pᵢ is required from the arrival of the delivery vehicle 4 to the end of the supply of the resource (where i is any integer of 1 or more to 6 or less). As described above, values independent of each other are applied to the grace time d and the stay time p for each delivery destination 5.

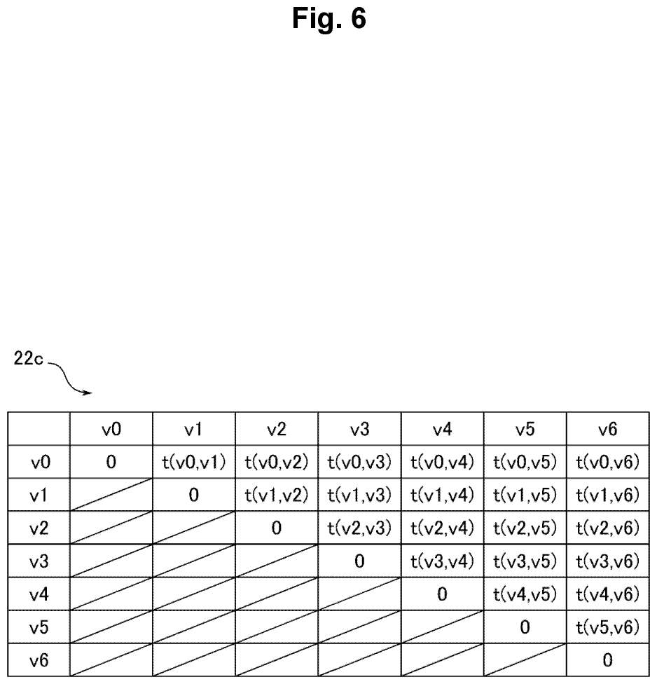

As illustrated in FIG. 6, the movement time information 22c is information indicating a movement time t. The movement time t is a time required for movement between the delivery vehicle 4 and any delivery destination 5 and between any two delivery destinations 5 (hereinafter, referred to as an “inter-vertex”). The movement time t is not necessarily proportional to a Euclidean distance between vertices. The movement time t may be determined, for example, in consideration of information such as a road connecting vertices. That is, the movement time t corresponds to the time required when actually moving on a road described on the map.

In the example in FIG. 6, the delivery support device 10 can ascertain that the movement time t between the vertex vᵢ and the vertex vⱼ is t(vᵢ, vⱼ) from the movement time information 22c (where j is an integer that is 0 or more and 6 or less and is different from i).

Returning to FIG. 3, the functional configuration of the delivery support device 10 will be described.

The route management unit 23 is a functional block for managing a route that can be taken when the delivery vehicle 4 delivers resources to the delivery destination 5. Each route is, for example, a delivery order defined under the constraint of starting from the current position of the delivery vehicle 4 and passing through all the delivery destinations 5 to which resources are to be delivered once. The route management unit 23 generates a route list L on the basis of the delivery vehicle information 22a and the delivery destination information 22b. The route list L is a set of routes.

The route management unit 23 extracts a route group P from the route list L in response to a request from the optimal route derivation unit 24. The route group P is a subset of the routes in the route list L. Specifically, for example, the route group P includes at least one route in which the delivery destination 5 to be delivered first is common among the delivery destinations 5 of which a delivery order is not determined in the route list L. The route management unit 23 transmits the extracted route group P to the optimal route derivation unit 24. The route management unit 23 deletes the route group P transmitted to the optimal route derivation unit 24 from the route list L.

The route management unit 23 adds a sub-route group P′ generated through a branching process by the optimal route derivation unit 24 to the route list L as a new route group P. The sub-route group P′ is a subset of routes in a certain route group P. Specifically, for example, the sub-route group P′ includes at least one route in which the delivery destination 5 to be delivered first is common among the delivery destinations 5 whose delivery order is not determined in a certain route group P. The branching process will be described later.

The optimal route derivation unit 24 is a functional block for deriving an optimal route from the route list L according to the branch-and-bound method. The optimal route is a route that minimizes the maximum exhaustion time Tₘₐₓ. The optimal route derivation unit 24 includes an upper limit value route selection unit 30, an upper limit value calculation unit 31, a first determination unit 32, an update unit 33, a relaxation problem setting unit 34, an idle time calculation unit 35, a lower limit value route selection unit 36, a lower limit value calculation unit 37, a second determination unit 38, and a branching unit 39.

The upper limit value route selection unit 30 is a functional block for selecting an upper limit value route r₁ from the route group P. The upper limit value route r₁ is a route used for calculating an upper limit value UB of the maximum exhaustion time Tₘₐₓ in the route group P. The upper limit value UB may be read as an upper bound. Specifically, for example, for the delivery destination 5 of which a delivery order is not determined in the route group P, the upper limit value route selection unit 30 selects a route sequentially heading for the delivery destination 5 having a shorter grace time d as the upper limit value route r₁. The upper limit value route selection unit 30 transmits the selected upper limit value route r₁ to the upper limit value calculation unit 31.

Note that, in the upper limit value route r₁, assuming that the order in which a resource is delivered to the delivery destination 5-i is k-th, a relationship between i and k is expressed by the following Formula (1). Here, when k=0, i=0.

$$\begin{matrix}[ Math . 1 ] & \\ i = {f}_{r 1} ( k ) & ( 1 )\end{matrix}$$

The upper limit value calculation unit 31 is a functional block for calculating the upper limit value UB on the basis of the upper limit value route r₁. Specifically, for example, the upper limit value calculation unit 31 calculates the time aᵢ (r₁) at which the delivery vehicle 4 arrives at the delivery destination 5-i on the upper limit value route r₁ according to the following Formula (2). Here, p₀=0.

$$\begin{matrix}[ Math . 2 ] & \\ {a}_{i} ( {r}_{1} ) = {a}_{{f}_{r 1} ( k )} ( {r}_{1} ) = ( {\sum }_{l = 1}^{k - 1} t ( \text{?} , \text{?} ) + \text{?} ) + t ( \text{?} , \text{?} ) & ( 2 )\end{matrix}$$

$$\text{?} \text{indicates text missing or illegible when filed}$$

The upper limit value calculation unit 31 calculates an exhaustion time Tᵢ (r₁) of the delivery destination 5-i on the upper limit value route r₁ on the basis of the calculated arrival time aᵢ (r₁) to the delivery destination 5-i according to the following Formula (3).

$$\begin{matrix}[ Math . 3 ] & \\ {T}_{i} ( {r}_{1} ) = {a}_{i} ( {r}_{1} ) - {d}_{i} & ( 3 )\end{matrix}$$

The maximum value of the exhaustion time Tᵢ (r₁) is the maximum exhaustion time Tₘₐₓ in the upper limit value route r₁. That is, the upper limit value calculation unit 31 calculates the upper limit value UB according to the following Formula (4). The upper limit value calculation unit 31 transmits the calculated upper limit value UB to the first determination unit 32.

$$\begin{matrix}[ Math . 4 ] & \\ UB = {max}_{i} {T}_{i} ( {r}_{1} ) & ( 4 )\end{matrix}$$

The first determination unit 32 is a functional block for determining whether or not to update the evaluation function in the branch-and-bound method. The first determination unit 32 determines whether or not the upper limit value UB is more than the evaluation function. In a case where the upper limit value UB is more than the evaluation function, the first determination unit 32 transmits the upper limit value UB to the update unit 33. In a case where the upper limit value UB is equal to or less than the evaluation function, the first determination unit 32 does not transmit the upper limit value UB to the update unit 33.

The update unit 33 is a functional block for updating the evaluation function. In a case where the upper limit value UB is received from the first determination unit 32, the update unit 33 updates the evaluation function with the upper limit value UB. The update unit 33 stores the updated evaluation function and the upper limit value route r₁ corresponding to the evaluation function in the memory 12 in association with each other.

The relaxation problem setting unit 34 is a functional block for setting a relaxation problem. The relaxation problem is a problem in which a difficulty level of solution derivation is relaxed by imposing constraints on an original problem (that is, a problem of deriving an optimal route that minimizes the maximum exhaustion time among routes for delivering resources to all the delivery destinations 5 on the map). The relaxation problem is applied when a lower limit value LB of the maximum exhaustion time Tₘₐₓ in the route group P is calculated. The lower limit value may be read as a lower bound. Specifically, the relaxation problem setting unit 34 imposes a constraint to aggregate all the delivery destinations 5 of which a delivery order is not determined in the route group P at an appropriate position. The appropriate position is, for example, a position of the delivery destination 5 of which a delivery order is the last among the delivery destinations 5 of which a delivery order is determined in the route group P. By imposing such a constraint, the movement time t between the delivery destinations 5 of which positions are aggregated can be regarded as 0.

In the following description, a vertex corresponding to the delivery destination 5-i of which a position is aggregated in the relaxation problem is set as a vertex v′ᵢ. A grace time and a stay time in the relaxation problem of the delivery destination 5-i corresponding to the vertex v′ᵢ are d′ᵢ and p′ᵢ, respectively. An arrival time and an exhaustion time in the relaxation problem of the delivery destination 5-i corresponding to the vertex v′ᵢ are a′ᵢ and T′ᵢ, respectively. The maximum exhaustion time based on the exhaustion time T′ᵢ is set to T′ max. Note that positions of all the vertices v′ᵢ match each other. The grace time d′ᵢ and the stay time p′ᵢ are set to values equal to the grace time dᵢ and the stay time pᵢ (d′ᵢ=dᵢ, p′ᵢ=pᵢ).

The idle time calculation unit 35 is a functional block for calculating an idle time It applied to the relaxation problem. For example, in the relaxation problem, the idle time It is defined as a time during which the supply of a resource is impossible after the delivery vehicle 4 finishes the supply of the resource to a certain delivery destination 5 until the supply of the resource to the next delivery destination 5 is started. The idle time It is calculated according to the movement time t in the original problem. Specifically, for example, an idle time Itj from the end of the supply of the resource to the delivery destination 5 corresponding to the vertex v′ᵢ to the start of the supply of the resource to the delivery destination 5 corresponding to the vertex v′ⱼ is expressed as the following Formula (5).

$$\begin{matrix}[ Math . 5 ] & \\ {It}_{j} = {min}_{i \neq j} t ( {v}_{i} , {v}_{j} ) & ( 5 )\end{matrix}$$

The idle time calculation unit 35 calculates the idle time It according to Formula (5). The idle time calculation unit 35 transmits the calculated idle time It to the lower limit value route selection unit 36.

The lower limit value route selection unit 36 is a functional block for selecting a lower limit value route r₂ from the route group P. The lower limit value route r₂ is a route used for calculating the lower limit value LB of the maximum exhaustion time Tₘₐₓ in the route group P. Specifically, for example, for the delivery destination 5 of which a position is aggregated according to the relaxation problem, the lower limit value route selection unit 36 selects a route sequentially heading for the delivery destination 5 having a smaller sum (d′+p′) of the grace time d′ and the stay time p′ as the lower limit value route r₂. The lower limit value route selection unit 36 transmits the selected lower limit value route r₂ to the lower limit value calculation unit 37.

Note that the above-described lower limit value route r₂ minimizes the maximum exhaustion time T′ₘₐₓ in the delivery destination 5 of which a position is aggregated according to the relaxation problem in the route group P. This is easily proved by using a framework of a delivery delay time minimization problem in a scheduling problem.

Note that, in the lower limit value route r₂, assuming that the order in which a resource is delivered to the delivery destination 5-i is the k-th, a relationship between i and k is expressed by the following Formula (6). Here, when k=0, i=0.

$$\begin{matrix}[ Math . 6 ] & \\ i = {f}_{r 2} ( k ) & ( 6 )\end{matrix}$$

The lower limit value calculation unit 37 is a functional block for calculating the lower limit value LB on the basis of the lower limit value route r₂. Specifically, for example, the lower limit value calculation unit 37 calculates a time a′ᵢ (r₂) at which the delivery vehicle 4 arrives at the delivery destination 5-i on the lower limit value route r₂ according to the following Formula (7).

$$\begin{matrix}[ Math . 7 ] & \\ {a}_{i}^{′} ( {r}_{2} ) = {a}_{{f}_{r 2} ( k )}^{′} ( {r}_{2} ) = ( {\sum }_{l = 1}^{k - 1} {It}_{{f}_{r 2} ( l )} + {p}_{{f}_{r 2} ( l )}^{′} ) + {It}_{{f}_{r 2} ( k )} & ( 7 )\end{matrix}$$

The lower limit value calculation unit 37 calculates an exhaustion time T′ᵢ (r₂) of the delivery destination 5-i in the lower limit value route r₂ on the basis of the calculated arrival time a′ᵢ (r₂) to the delivery destination 5-i according to the following Formula (8).

$$\begin{matrix}[ Math . 8 ] & \\ {T}_{i}^{′} ( {r}_{2} ) = {a}_{i}^{′} ( {r}_{2} ) - {d}_{i}^{′} & ( 8 )\end{matrix}$$

The maximum value of the exhaustion time T′ᵢ (r₂) is the maximum exhaustion time T′ₘₐₓ in the lower limit value route r₂. That is, the lower limit value calculation unit 37 calculates the lower limit value LB according to the following Formula (9). The lower limit value calculation unit 37 transmits the calculated lower limit value LB to the second determination unit 38.

$$\begin{matrix}[ Math . 9 ] & \\ LB = {max}_{i} {T}_{i}^{′} ( {r}_{2} ) & ( 9 )\end{matrix}$$

The second determination unit 38 is a functional block for determining whether or not to execute the branching process in the branch-and-bound method. The second determination unit 38 determines whether or not the lower limit value LB is less than the evaluation function. In a case where the lower limit value LB is less than the evaluation function, the second determination unit 38 transmits the lower limit value LB to the branching unit 39. In a case where the lower limit value LB is equal to or more than the evaluation function, the second determination unit 38 transmits the determination result to the route management unit 23 without transmitting the lower limit value LB to the branching unit 39.

The branching unit 39 is a functional block for performing the branching process. The branching process is a process of classifying a plurality of routes in the route group P into a plurality of sub-route groups P′ each including at least one route. Specifically, for example, in a case where the lower limit value LB is received from the second determination unit 38, the branching unit 39 classifies at least one route in which the delivery destination 5 to be delivered first is common among the delivery destinations 5 of which the delivery order is not determined in the route group P into the same sub-route group P′. The branching unit 39 transmits the generated sub-route group P′ to the route management unit 23.

The output unit 25 is a functional block for outputting the optimal route to a user. In a case where the route list L managed by the route management unit 23 is an empty set, the output unit 25 outputs a set of the evaluation function stored by the update unit 33 and a route corresponding to the evaluation function to the user as the optimal route.

With the above configuration, the user can obtain, from the delivery support device 10, a route that minimizes the maximum exhaustion time Tₘₐₓ as the optimal route as information for supporting a delivery plan. The user can generate a delivery plan on the basis of the information.

### 2. OPERATION

Next, operation of the delivery support device according to the embodiment will be described.

### 2.1 Delivery Support Operation

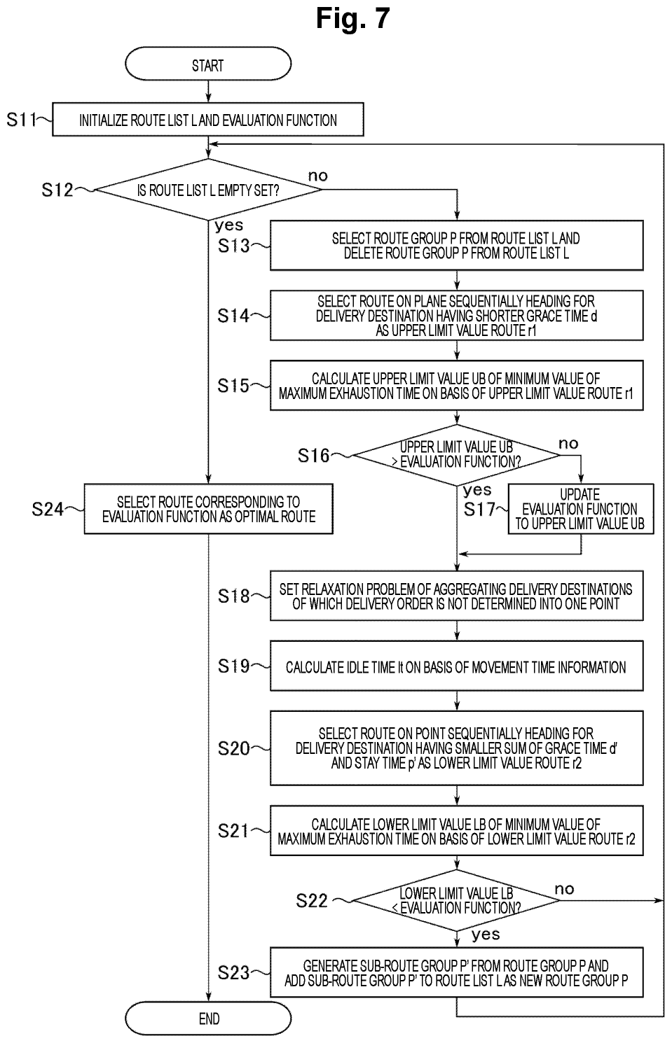

FIG. 7 is a flowchart illustrating an example of a delivery support operation in the delivery support device according to the embodiment. In the example in FIG. 7, it is assumed that the delivery vehicle information 22a, the delivery destination information 22b, and the movement time information 22c are stored in the memory 12 in advance through user input.

As illustrated in FIG. 7, when an instruction to select an optimal route is received from a user (start), the route management unit 23 initializes the route list L and the evaluation function (S11). For example, the route management unit 23 causes all routes that can be realized by the delivery destination 5 that delivers resources to be included in the route list L. The route management unit 23 temporarily initializes the evaluation function to be minimized to infinity (=+∞).

The route management unit 23 determines whether or not the route list L is an empty set (S12).

In a case where the route list L is not an empty set (S12; no), the route management unit 23 selects the route group P from the route list L and deletes the selected route group P from the route list L (S13).

The upper limit value route selection unit 30 selects the upper limit value route r₁ from the route group P selected in the process in S13. Specifically, the upper limit value route selection unit 30 selects a route on a plane sequentially heading for the delivery destination 5 having a shorter grace time d as the upper limit value route r₁ (S14).

The upper limit value calculation unit 31 calculates the upper limit value UB of the minimum value of the maximum exhaustion time Tₘₐₓ on the basis of the upper limit value route r₁ selected in the process in S14 (S15).

The first determination unit 32 determines whether or not the upper limit value UB calculated in the process in S15 is more than the evaluation function (S16).

In a case where the upper limit value UB is equal to or less than the evaluation function (S16; no), the update unit 33 updates the evaluation function to the upper limit value UB (S17). The update unit 33 stores the updated upper limit value UB and the route corresponding to the upper limit value UB in the memory 12.

In a case where the upper limit value UB is more than the evaluation function (S16; yes), or after the process in S17, the relaxation problem setting unit 34 sets a relaxation problem for aggregating the delivery destinations 5 of which a delivery order is not determined in the route group P into one point (S18).

After the process in S18, the idle time calculation unit 35 calculates the idle time It in the relaxation problem on the basis of the movement time information 22c (S19).

The lower limit value route selection unit 36 selects a route on a point optimally selected on the basis of a delivery delay minimization problem in the scheduling problem as the lower limit value route r₂. Specifically, for the delivery destination 5 aggregated into one point through the process in S18, the lower limit value route selection unit 36 selects a route on a point sequentially heading for the delivery destination 5 having a smaller sum (d′+p′) of the grace time d′ and the stay time p′ as the lower limit value route r₂ (S20).

The lower limit value calculation unit 37 calculates the lower limit value LB of the minimum value of the maximum exhaustion time Tₘₐₓ on the basis of the lower limit value route r₂ selected in the process in S20 (S21).

The second determination unit 38 determines whether or not the lower limit value LB calculated in the process in S21 is less than the evaluation function (S22).

In a case where the lower limit value LB is less than the evaluation function (S22; yes), the branching unit 39 generates the sub-route group P′ from the route group P and transmits the generated sub-route group P′ to the route management unit 23 (S23). The route management unit 23 adds the sub-route group P′ received from the branching unit 39 to the route list L as a new route group P.

In a case where the lower limit value LB is equal to or more than the evaluation function (S22; no) or after the process in S23, the route management unit 23 determines whether or not the route list L is an empty set (S12). As described above, the processes in S13 to S23 are repeatedly executed until the route list L becomes an empty set. As a result, the evaluation function is updated while selecting a route according to the branch-and-bound method.

In a case where the route list L is an empty set (S12; yes), the optimal route derivation unit 24 selects a route corresponding to the evaluation function finally updated through the process in S17 as the optimal route (S24).

In a case where the process in S24 is ended, the delivery support operation is ended (end). As a result, the output unit 25 can output the selected optimal route to the user.

### 2.2 Specific Example of Lower Limit Value Calculation

Next, a specific example of calculation of the lower limit value LB in the relaxation problem will be described. Hereinafter, it is assumed that the relaxation problem is applied to the route group P in a case where a delivery order of the delivery destinations 5-1 to 5-6 is not determined.

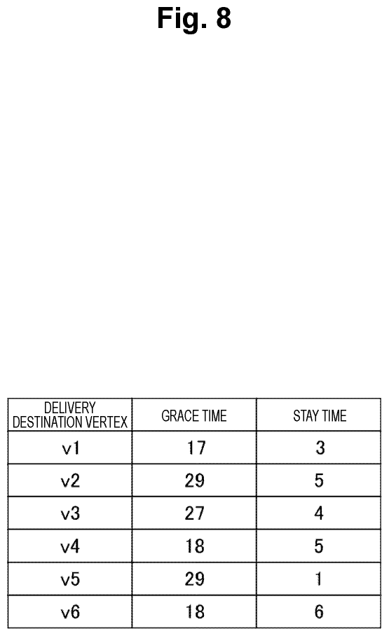

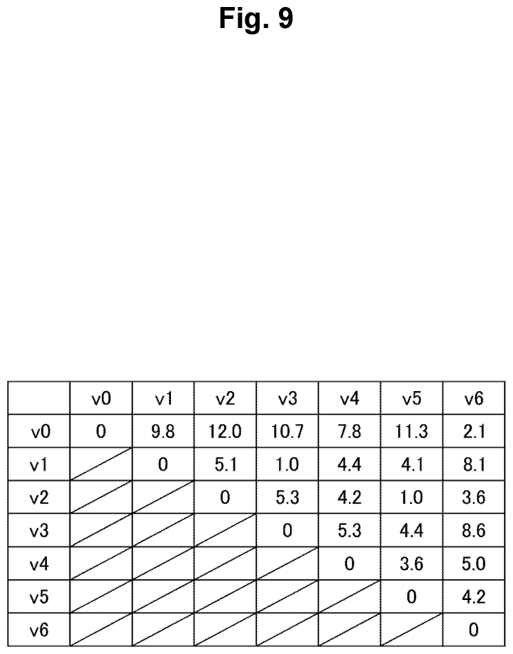

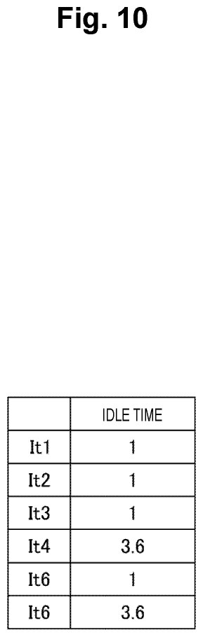

FIG. 8 is a diagram illustrating a grace time and a stay time in a specific example. FIG. 9 is a diagram illustrating a movement time in a specific example. FIG. 10 is a diagram illustrating an idle time in a specific example.

As illustrated in FIG. 8, a case where the grace time d and the stay time p at the vertices v₁ to v₆ are given will be considered. That is, it is assumed that (d₁, p₁)=(17, 3), (d₂, p₂)=(29, 5), (d₃, p₃)=(27, 4), (d₄, p₄)=(18, 5), (d₅, p₅)=(29, 1), and (d₆, p₆)=(18, 6).

As illustrated in FIG. 9, a case where the inter-vertex movement time t at the vertices v₀ to v₆ is given is considered. That is, it is assumed that t(v₀, v₁)=9.8, t(v₀, v₂)=12.0, t(v₀, v₃)=10.7, t(v₀, v₄)=11.3, t(v₀, v₅)=11.3, t(v₀, v₆)=2.1, t(v₁, v₂)=5.1, t(v₁, v₃)=1.0, t(v₁, v₄)=4.4, t(v₁, v₅)=4.1, t(v₁, v₆)=8.1, t(v₂, v₃)=5.3, t(v₂, v₄)=4.2, t(v₂, v₅)=1.0, t(v₂, v₆)=3.6, t (v₃, v₄)=5.3, t (v₃, v₅)=4.4, t (v₃, v₆)=8.6, t (v₄, v₅)=3.6, t(v₄, v₆)=5.0, and t (v₅, v₆)=4.2.

The idle time calculation unit 35 calculates the idle time It as illustrated in FIG. 10 according to the above Formula (5) on the basis of the above movement time t. That is, the idle time calculation unit 35 calculates It₁=1, It₂=1, It₃=1, It₄=3.6, It₅=1, and It₆=3.6.

The lower limit value route selection unit 36 selects a route sequentially heading for the delivery destination 5 having a smaller sum (d′+p′) of the grace time d′ and the stay time p′ as the lower limit value route r₂. As described above, since dᵢ=d′ᵢ and pᵢ=p′ᵢ, the delivery destination 5 having a smaller sum (d′+p′) of the grace time d′ and the stay time p′ is 5-1, 5-4, 5-6, 5-5, 5-3, and 5-2 in this order. Thus, the lower limit value route selection unit 36 selects a route for delivering resources in the order of the vertices v′1, v′4, v′6, v′5, v′3, and v′2 as the lower limit value route r₂.

The lower limit value calculation unit 37 calculates the arrival time a′ᵢ (r₂) according to the above Formula (7). Specifically, the lower limit value calculation unit 37 calculates a′₁ (r₂)=1.0, a′₄ (r₂)=7.6, a′₆ (r₂)=16.2, a′₅ (r₂)=23.2, a′₃ (r₂)=25.2, and a′₂ (r₂)=30.2.

The lower limit value calculation unit 37 calculates the exhaustion time T′ᵢ (r₂) according to the above-described Formula (8). Specifically, the lower limit value calculation unit 37 calculates T′₁ (r₂)=−16.0, T′₄ (r₂)=−10.4, T′₆ (r₂)=−1.8, T′₅ (r₂)=−5.8, T′₃ (r₂)=−1.8, and T′₂ (r₂)=1.2. The lower limit value calculation unit 37 calculates the maximum value T′ₘₐₓ=T′₂ (12)=1.2 of the calculated exhaustion time T′ᵢ (r₂) as the lower limit value LB.

The lower limit value LB is calculated through the above processing. Note that the minimum delay time (optimal value) in the resource delivery route from the vertex v₀ to the vertices v₁ to v₆ described above is 16.5 by total enumeration. The lower limit value LB is calculated to fall below this optimal value. This ensures that the solution finally obtained according to the branch-and-bound method by using the relaxation problem set in the present embodiment is an exact solution.

### 1.3 Effects According to Embodiment

According to the embodiment, the optimal route derivation unit 24 derives an optimal route on the basis of the branch-and-bound method using a relaxation problem of aggregating the delivery destinations 5 of which a delivery order is not determined into one point. Such a relaxation problem can be proved that an optimal solution can be obtained by using a framework of a delivery delay time minimization problem in a scheduling problem. This can ensure that the solution obtained according to the branch-and-bound method by using the relaxation problem is an exact solution.

Specifically, the lower limit value route selection unit 36 selects, as the lower limit value route r₂, a delivery route in ascending order of the sum of the grace time d′ and the stay time p′. The lower limit value calculation unit 37 calculates the maximum exhaustion time T′ max calculated on the basis of the lower limit value route r₂ as the lower limit value LB. As a result, it is possible to efficiently obtain an optimal resource delivery route. Note that the grace time d′ and the stay time p′ in the relaxation problem are set not to change from the grace time d and the stay time p in the original problem, respectively. As a result, an optimal value obtained by the relaxation problem can always be smaller than an optimal value of the original problem.

The stay times p are set independently of each other among the plurality of delivery destinations 5. As a result, it is possible to derive a route that minimizes the maximum exhaustion time while considering a case where the stay time p is different for each delivery destination 5.

The idle time calculation unit 35 calculates the idle time It according to the movement time t of the delivery vehicle 4 between the delivery destinations 5. As a result, in the relaxation problem, settings of the original problem can be reflected, and the lower limit value LB can be suppressed from greatly deviating from the optimal value of the original problem.

The upper limit value route selection unit 30 selects a delivery route in ascending order of the grace time d as the upper limit value route r₁. The upper limit value calculation unit 31 calculates the maximum exhaustion time Tₘₐₓ calculated on the basis of the upper limit value route r₁ as the upper limit value UB. As a result, a value of the evaluation function in the branch-and-bound method can be updated.

The output unit 25 outputs the derived optimal route to a user. As a result, the user can ascertain in which order the delivery vehicle 4 is caused to head for the delivery destination 5 to minimize the maximum exhaustion time. Therefore, the delivery support device 10 can support creation of a more accurate delivery plan.

### 3. OTHERS

Various modifications can be made in the embodiment described above.

For example, in the embodiment described above, a case where the delivery support program is executed by the delivery support device 10 in the delivery support center 2 has been described, but the present invention is not limited thereto. For example, the delivery support program may be executed by a calculation resource on a cloud.

Note that the present invention is not limited to the above-described embodiment, and various modifications can be made at the implementation stage without departing from the concept of the invention. The respective embodiments may be implemented in appropriate combination, and in that case, a combined effect can be achieved. The above embodiments include various types of inventions, and various types of inventions can be extracted according to a combination selected from a plurality of disclosed components. For example, even if some components are eliminated from all the components described in the embodiment, a configuration from which the components are eliminated can be extracted as an invention in a case where the problem can be solved and the advantageous effects can be achieved.

### REFERENCE SIGNS LIST

1 Delivery system
2 Delivery support center
3 Delivery base
4 Delivery vehicle
5-1, 5-2, 5-3, 5-4, 5-5, 5-6 Delivery destination
10 Delivery support device
11 Control circuit
12 Memory
13 Communication module
14 User interface
15 Drive
16 Storage medium
21 Input unit
22 Storage unit
22a Delivery vehicle information
22b Delivery destination information
22c Movement time information
23 Route management unit
24 Optimal route derivation unit
25 Output unit
30 Upper limit value route selection unit
31 Upper limit value calculation unit
32 First determination unit
33 Update unit
34 Relaxation problem setting unit
35 Idle time calculation unit
36 Lower limit value route selection unit
37 Lower limit value calculation unit
38 Second determination unit
39 Branching unit

1. A delivery support device comprising:
a derivation unit, including one or more processors, configured to derive a route of a resource in a delivery apparatus, for minimizing a maximum value of a time during which the resource is exhausted at a plurality of first locations, wherein
the derivation unit is configured to derive the route based on a branch-and-bound method using a relaxation problem of aggregating a plurality of second locations of which a delivery order is not determined among the plurality of first locations into one point.

2. The delivery support device according to claim 1, wherein
each of the plurality of first locations is associated with an exhaustion time of the resource and a stay time of the delivery apparatus; and
the derivation unit includes:
a first route selection unit, including one or more processors, configured to select a first route for delivering the resource to the plurality of second locations based on a sum of the exhaustion time and the stay time; and
a first calculation unit, including one or more processors, configured to calculate a lower limit value of the maximum value based on the first route.

3. The delivery support device according to claim 2, wherein
the stay time is independent among the plurality of first locations.

4. The delivery support device according to claim 2, wherein
the derivation unit further includes a second calculation unit, including one or more processors, configured to calculate an idle time associated with each of the plurality of second locations according to a movement time of the delivery apparatus between the plurality of second locations, and
the first calculation unit is configured to calculate the lower limit value further based on the idle time.

5. The delivery support device according to claim 2, wherein
the first route is an optimal solution based on a delivery delay time minimization problem in a scheduling problem.

6. The delivery support device according to claim 2, wherein
the derivation unit further includes:
a second route selection unit, including one or more processors, configured to select a second route for delivering the resource to the plurality of first locations based on the exhaustion time; and
a third calculation unit, including one or more processors, configured to calculate an upper limit value of the maximum value based on the second route.

7. A delivery support method comprising:
deriving a route of a resource in a delivery apparatus, for minimizing a maximum value of a time during which the resource is exhausted at a plurality of first locations based on a branch-and-bound method using a relaxation problem of aggregating a plurality of second locations of which a delivery order is not determined among the plurality of first locations into one point.

8. A delivery support program for causing a computer to function as each unit included in the delivery support device according to claim 1.
